(19) United States
(12) Patent Application Publication
(10) Pub. No.: US 2026/0171293 A1
(43) Pub. Date: Jun. 18, 2026

(54) MAGNETIC UNIT

(71) Applicant: Yazaki Corporation, Tokyo (JP)

(72) Inventors: Masayo MATSUURA, Shizuoka (JP); Takuto MISHIGE, Shizuoka (JP); Kenji SEGAWA, Shizuoka (JP); Takanori KANAMORI, Shizuoka (JP); Junya ISHIDA, Shizuoka (JP)

(73) Assignee: Yazaki Corporation, Tokyo (JP)

(21) Appl. No.: 19/419,289

(22) Filed: Dec. 15, 2025

(30) Foreign Application Priority Data
Dec. 16, 2024 (JP) 2024-219681

(51) Int. Cl. H01F 27/24; H01F 27/02

(52) U.S. Cl. CPC H01F 27/24; H01F 27/02

(57) ABSTRACT

A magnetic unit includes: a magnetic core formed in an annular shape about a first direction and including a first core and a second core split along a second direction, in which the first core and the second core are in contact with each other along a third direction; a base member that includes a bottom part and a sidewall part; a cover including a support part that is provided facing the second core and a cover side part that is provided facing the sidewall part; and a plate spring configured to energize the second core toward the first core. A base side locking part provided at the sidewall part and a cover side locking part provided at the cover side part are locked to each other by being moved relatively in a direction in which the cover and the base member approach each other.

### CROSS-REFERENCE TO RELATED APPLICATION(S)

The present application claims priority to and incorporates by reference the entire contents of Japanese Patent Application No. 2024-219681 filed in Japan on Dec. 16, 2024.

### BACKGROUND OF THE INVENTION

### 1. Field of the Invention

The present invention relates to a magnetic unit.

### 2. Description of the Related Art

As one example of the conventional art regarding a magnetic unit according to Japanese Patent Application Laid-open No. 2019-165138, a first holder includes a base part that positions a first core by incorporating the first core on one surface side of a substrate, and two penetration parts that position a second core on the other surface side of the substrate while penetrating two holes of the substrate. A second holder holds the first core and the second core by being assembled to the two penetration parts on the other surface side of the substrate.

In such a magnetic unit, incidentally, the magnetic core including the first core and the second core may be held by having the first core and the second core in contact with each other with a strong force. Therefore, there is room for further improvement in a locking structure for the two members to hold the magnetic core as a locking structure of the base part that incorporates the first core and the second holder that is locked to the base part.

### SUMMARY OF THE INVENTION

The present invention is made in view of such a situation, and provides a magnetic unit according that the magnetic core can be properly held.

In order to achieve the above mentioned object, a magnetic unit according to one aspect of the present invention includes a magnetic core formed in an annular shape about a first direction and including a first core and a second core split along a second direction that intersects with the first direction, in which the first core and the second core are in contact with each other along a third direction that intersects with the first direction and the second direction; a base member that accommodates the magnetic core and includes a bottom part that supports the first core and a sidewall part that is provided on a side of the magnetic core in the second direction; a cover including a support part that is provided facing the second core in the third direction and a cover side part that is provided facing the sidewall part in the second direction; and an energizing member provided between the support part and the second core and configured to energize the second core toward the first core along the third direction, wherein a base side locking part is provided at the sidewall part, a cover side locking part is provided at the cover side part, and the base side locking part and the cover side locking part are locked to each other by being moved relatively in a direction in which the cover and the base member approach each other along the first direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a magnetic unit according to an embodiment;

FIG. 2 is an exploded perspective view illustrating the magnetic unit according to the embodiment;

FIG. 3 is a perspective view illustrating a base member according to the embodiment;

FIG. 4 is a perspective view illustrating a bobbin according to the embodiment;

FIG. 5 is a perspective view illustrating a cover to which a plate spring according to the embodiment is attached;

FIG. 6 is a cross-sectional view taken along VI-VI in FIG. 1;

FIG. 7 is a cross-sectional view taken along VII-VII in FIG. 1;

FIG. 8 is a perspective view illustrating a state before the cover is attached to the base member according to the embodiment;

FIG. 9 is a perspective view illustrating a state before the cover attached to the base member according to the embodiment is slid;

FIG. 10 is a cross-sectional view taken along X-X in FIG. 9;

FIG. 11 is a partially enlarged cross-sectional perspective view taken along XI-XI in FIG. 9;

FIG. 12 is a cross-sectional view corresponding to the X-X cross section in FIG. 9 after the sliding operation of the cover; and

FIG. 13 is a partially enlarged cross-sectional perspective view corresponding to the XI-XI cross section in FIG. 9 after the sliding operation of the cover.

### DETAILED DESCRIPTION OF THE PREFERRED EMBODIMENTS

Embodiments according to the present invention will hereinafter be described in detail on the basis of the drawings. Note that the present invention is not limited by the embodiments. In addition, the components in the following embodiments include those that are substitutable and easily conceivable for persons who are skilled in the art, or those that are substantially the same.

### Embodiment

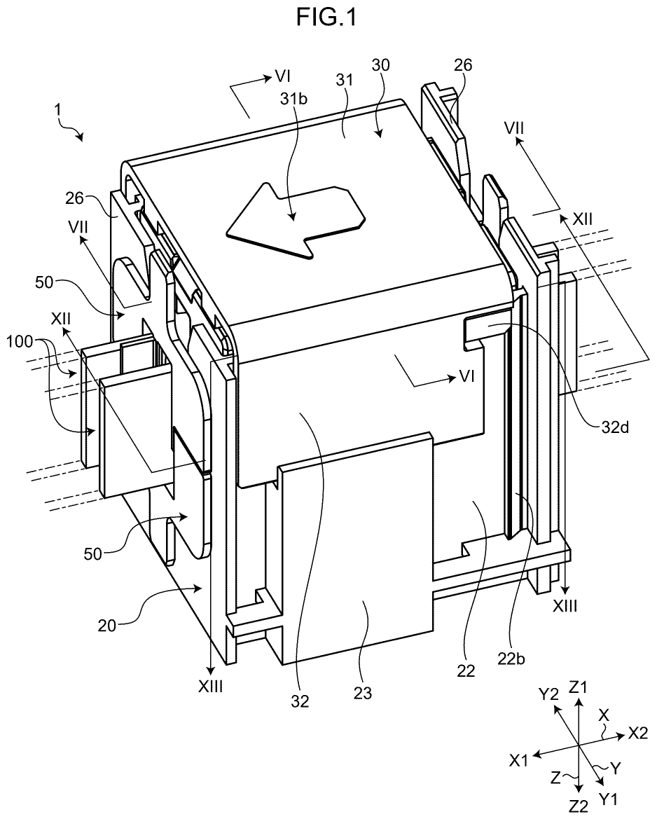

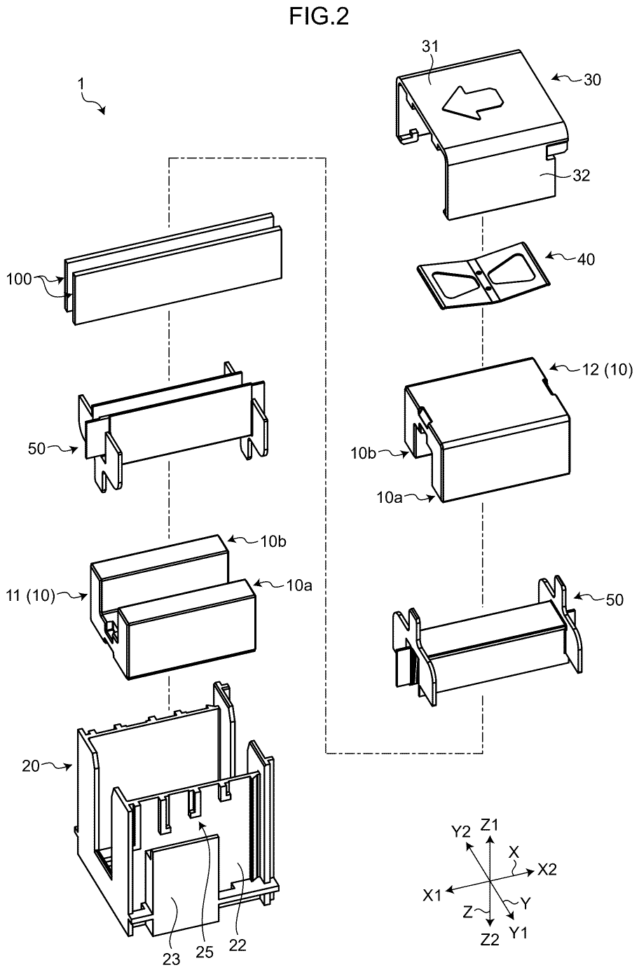

A magnetic unit 1 according to the embodiment illustrated in FIG. 1 and FIG. 2 is, for example, provided in a high-voltage junction box to which a high-voltage battery pack mounted in a vehicle, such as an electric vehicle or a hybrid vehicle, is electrically connected. In the magnetic unit 1, busbars 100 are inserted to a magnetic core 10 with an annular shape that includes split cores, that is, a first core 11 and a second core 12. The busbar 100 is a circuit body (conductor) that forms a high-voltage circuit system including a high-voltage battery pack and the like. The magnetic unit 1 including the magnetic core 10 can suitably remove high-frequency noise in the busbar 100 and suitably suppress surge voltages.

The magnetic unit 1 includes the magnetic core 10, a base member 20, a cover 30, a plate spring 40 as an energizing member, and two bobbins 50. Two busbars 100 are inserted to the magnetic core 10, which is formed in an annular shape. The busbar 100 is formed in a long shape, and is illustrated only partially in the drawing.

In the following description, an axial direction of the annular magnetic core 10 in which the two busbars 100 extend is a first direction X, and two directions that are orthogonal to the first direction X are a second direction Y and a third direction Z. The second direction Y is the direction in which the two busbars 100 are arranged. One side in the first direction X is described as one side X1 and the other side is described as the other side X2 below. Similarly, one side and the other side in the second direction Y are described as one side Y1 and the other side Y2 and one side and the other side in the third direction Z are described as one side Z1 and the other side Z2, respectively.

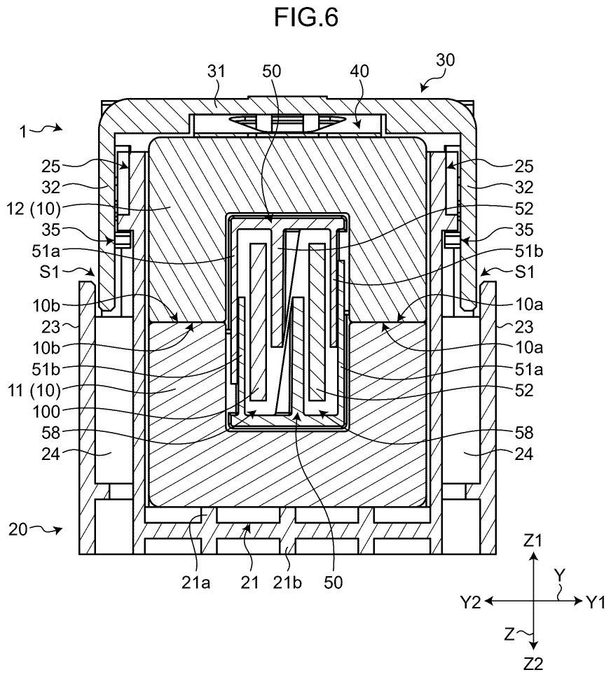

As illustrated in FIG. 2, the magnetic core 10 includes the first core 11 and the second core 12 split along the second direction Y. The magnetic core 10 is formed annularly about the first direction X with the first core 11 and the second core 12 combined (see also FIG. 6). The first core 11 and the second core 12 are formed in the same shape and are formed of a magnetic material such as ferrite. The first core 11 and the second core 12 have an approximately U-like shape as viewed from the first direction X, and are long along the first direction X. Of the first core 11 and the second core 12, two flat surfaces located on the open side of the approximately U-like shape are contact surfaces 10a and 10b. In the magnetic core 10, the respective contact surfaces 10a and 10b of the first core 11 and the second core 12 are in contact with each other along the third direction Z.

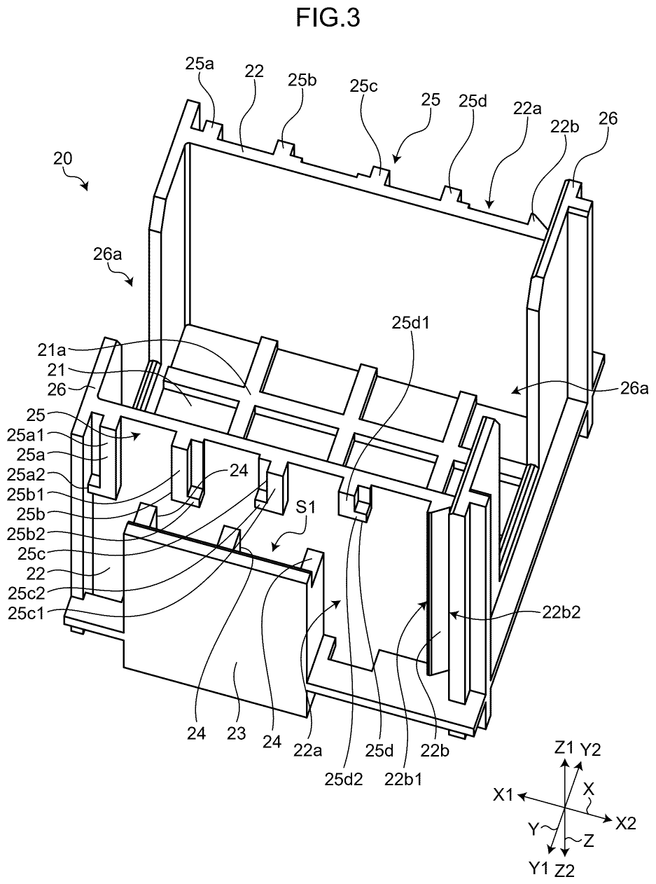

As illustrated in FIG. 3, the base member 20 is formed in an approximately cuboid box-like shape with an opening on one side Z1 in the third direction Z. The base member 20 has an approximately long rectangular plate-shaped bottom part 21 that is approximately parallel to a plane containing the first direction X and the second direction Y. On one side Z1 of the bottom part 21 in the third direction Z, a core support part 21a is formed in a grid pattern. A surface of the core support part 21a on one side Z1 in the third direction Z is in contact with, and supports the surface of the first core 11 on the other side Z2 in the third direction Z. As illustrated in FIG. 6, a rib 21b with the grid pattern similar to that of the core support part 21a is also formed at the bottom part 21 on the other side Z2 in the third direction Z.

As illustrated in FIG. 3, in the vicinity of an end part of the bottom part 21 on one side Y1 in the second direction Y and in the vicinity of an end part thereof on the other side Y2, two sidewall parts 22 rising toward one side Z1 in the third direction Z are provided. Each sidewall part 22 has an approximately plate-like shape with its plate surface facing in the second direction Y. The sidewall parts 22 are located on the side of the magnetic core 10 in the second direction Y. On an outer side surface 22a of each sidewall part 22, a base side locking part 25 is provided so as to project from the outer side surface 22a. Each base side locking part 25 has four base side locking parts 25a to 25d. The base side locking part 25a is provided on one side X1 in the first direction X, and the base side locking parts 25b, 25c, and 25d are provided in order toward the other side X2 in the first direction X.

Each of the base side locking parts 25a to 25d is formed in an approximately L-like shape when viewed from the second direction Y. The base side locking parts 25a to 25d respectively include locking support parts 25a1 , 25b1 , 25c1 , and 25d1 with a long prism shape that is long along the third direction Z, and locking reception parts 25a2, 25b2, 25c2, and 25d2 that are provided so as to project from the locking support parts 25a1, 25b1, 25c1, and 25d2 along the first direction X. Among the locking support parts 25a1, 25b1, 25c1, and 25d1, the locking support part 25a1 is the longest in the third direction Z, followed by the locking support parts 25b1, 25c1, and 25d1 in this order. The base side locking parts 25a to 25c (the locking reception parts 25a2 to 25c2) exist on the other side Z2 in the third direction Z compared to the base side locking parts 25b to 25d (the locking reception parts 25b2 to 25d2) that are adjacent on the other side X2 in the first direction X. That is to say, the base side locking parts 25a to 25d (the locking reception parts 25a2 to 25d2) are provided displaced along the third direction Z. In other words, the base side locking parts 25a to 25d (the locking reception parts 25a2 to 25d2) are disposed stepwise. The locking reception parts 25a2 and 25c2 of the base side locking parts 25a and 25c project toward one side X1 in the first direction X. The locking reception parts 25b2 and 25d2 of the base side locking parts 25b and 25d project toward the other side X2 in the first direction X. Thus, the base side locking parts 25a to 25d and cover side locking parts 35a to 35d (which will be described below) that are locked to the base side locking parts 25a to 25d can be disposed with the distance therebetween narrowed in the first direction X.

In the base member 20, a regulatory rib 23 with an approximately plate-like shape is provided on the outside of each sidewall part 22 in the second direction Y. The regulatory rib 23 regulates the movement of the cover 30, which will be described below, to the outside of the cover side part 32 in the second direction Y. Each regulatory rib 23 is disposed with its plate surface facing in the second direction Y, and is disposed with a distance from the sidewall part 22 to the outside along the second direction Y. Each regulatory rib 23 connects to the sidewall part 22 by three vertical ribs 24. On one side Z1 of the three vertical ribs 24 in the third direction Z, a space S1 is formed between the regulatory rib 23 and the sidewall part 22.

At an end part of each of the sidewall parts 22 on the other side X2 in the first direction X, a locking protrusion 22b is provided. The locking protrusion 22b is locked with a locking projection part 32d of the cover 30 described below. The locking protrusion 22b is long along the third direction Z. The locking protrusion 22b has the same length as the sidewall part 22 in the third direction Z. The locking protrusion 22b is formed so that its cross section at a plane containing the first direction X and the second direction Y has a mountain shape (that is, mountain-shaped cross section). One side X1 of the locking protrusion 22b in the first direction X corresponds to a locking surface 22b1 that is perpendicular to the outer side surface 22a of the sidewall part 22. A surface of the locking protrusion 22b on the other side X2 in the first direction X that is connected to the locking surface 22b1 corresponds to an inclined surface 22b2.

At each end part of each of the sidewall parts 22 on one side X1 and the other side X2 in the first direction X, an insertion plate part 26 with an approximately plate-like shape is provided. Each of the insertion plate parts 26 is provided with its plate surface facing in the first direction X. Each of the insertion plate parts 26 has an insertion opening 26a that is long along the third direction Z at a substantial center in the second direction Y. The bobbin 50 is disposed in the insertion opening 26a and the busbar 100 is inserted therethrough.

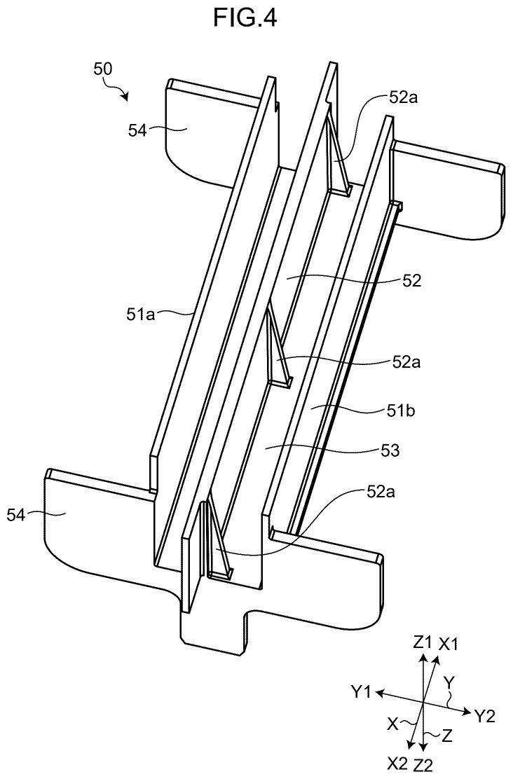

As illustrated in FIG. 2, the two bobbins 50 are provided facing each other along the third direction Z. Note that the two bobbins 50 are identical in shape. As illustrated in FIG. 4, the bobbin 50 includes two side plates 51a and 51b provided apart from each other, and a partition plate 52 provided between the two side plates 51a and 51b. Each of the side plates 51a and 51b and the partition plate 52 is formed in an approximately long rectangular shape that is long in the first direction X and has its plate surface facing in the second direction Y. Each of the side plates 51a and 51b and the partition plate 52 is connected by a bottom plate 53 at an end part on the other side Z2 in the third direction Z. The height, in the third direction Z, of the side plate 51a on one side Y1 in the second direction Y as illustrated in FIG. 4 is higher than that of the side plate 51b on the other side Y2 and the partition plate 52. On the other side Y2 of the partition plate 52 in the second direction Y, three ribs 52a that connect to the bottom plate 53 are provided. In each of the side plates 51a and 51b, a stop plate 54 is provided at each of end parts on one side X1 and the other side X2 in the first direction X. The stop plate 54 is provided with its plate surface facing in the first direction X. The stop plate 54 has an opening corresponding to the space between the side plates 51a and 51b and includes a part projecting to the outside of the side plates 51a and 51b.

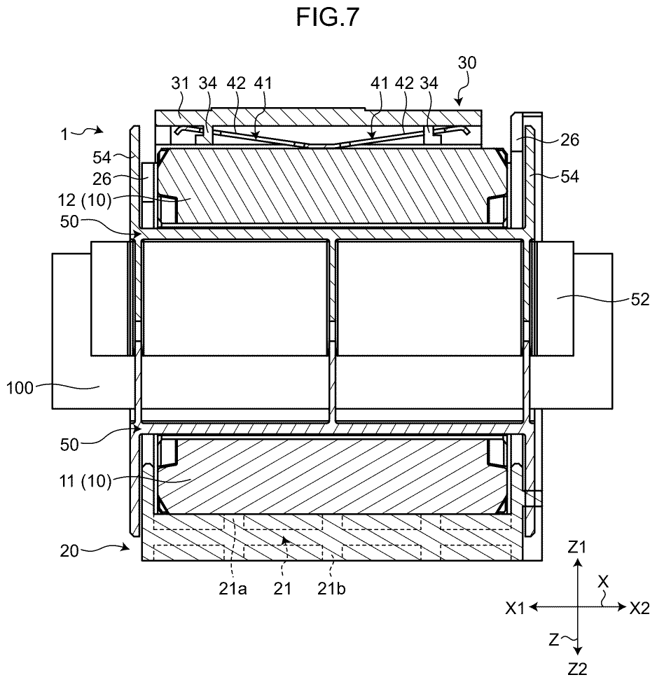

As illustrated in FIG. 6, the two bobbins 50 facing each other in the third direction Z are disposed inside the annular shape of the magnetic core 10, and busbar insertion paths 58 are formed on one side Y1 and the other side Y2 of the partition plates 52 in the second direction Y. Note that the partition plates 52 overlap with each other near the end part in the third direction Z. In addition, as illustrated in FIG. 7, an inner side surface of the stop plate 54 of each bobbin 50 is close to, or in contact with an outer side surface of the insertion plate part 26 of the base member 20.

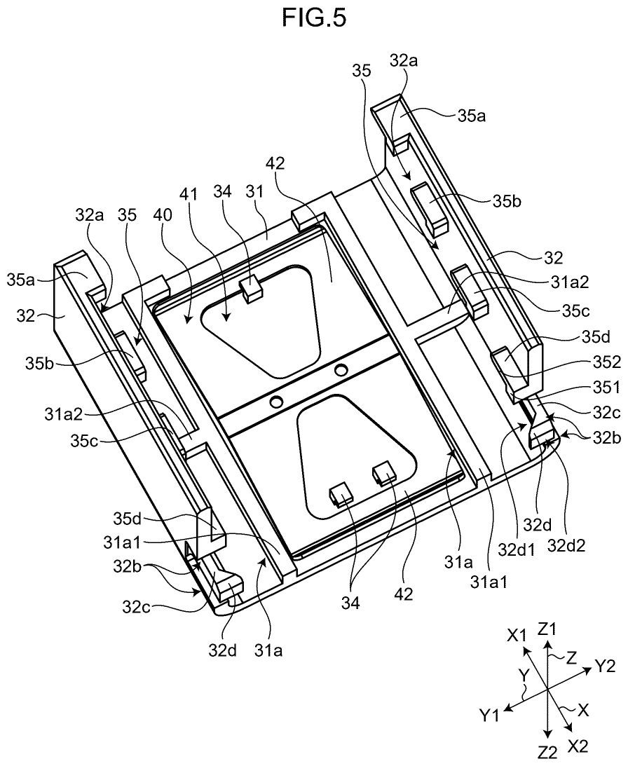

As illustrated in FIG. 2 and FIG. 5, the cover 30 includes a support part 31 and cover side parts 32. The support part 31 has an approximately rectangular plate-like shape with its plate surface facing in the third direction Z. The support part 31 is provided facing the second core 12 in the third direction Z (see FIG. 6 and FIG. 7). At an inner side surface of the support part 31, a pair of frame ribs 31a facing each other in the second direction Y are provided. The frame rib 31a includes a main frame rib 31a1 that is long in the first direction X and has an end part on one side X1 with a part projecting inward, and an auxiliary rib 31a2 connecting between the main frame rib 31a1 and an inner side surface 32a of the cover side part 32. Between the frame ribs 31a, the plate spring 40 (energizing member) is provided.

At the inner side surface of the support part 31 of the cover 30, three plate spring projections 34 formed in an approximately hook-like shape are provided. The plate spring projection 34 is disposed in a manner of being able to come into contact with an edge part of an opening 41 of the plate spring 40. With the plate spring projection 34, the movement of the plate spring 40 in a direction along the first direction X relative to the cover 30 is regulated. Note that a surface of the support part 31 of the cover 30 on one side Z1 in the third direction Z includes an arrow display part 31b indicating a direction of sliding when the cover 30 is assembled to the base member 20. The arrow display part 31b is an arrow directed to one side X1 in the first direction X. In addition, the plate spring 40 includes two leg parts 42 formed in an approximately mountain shape.

The cover side parts 32 are formed in an approximately rectangular plate-like shape extending to the other side Z2 in the third direction Z from an end part of the support part 31 on one side Y1 and an end part thereof on the other side Y2 in the second direction Y. The cover side parts 32 are provided facing the sidewall parts 22 of the base member 20 in the second direction Y (see FIG. 6). The cover 30 is formed in an approximately U-like shape when viewed from the first direction X by the support part 31 and the cover side parts 32.

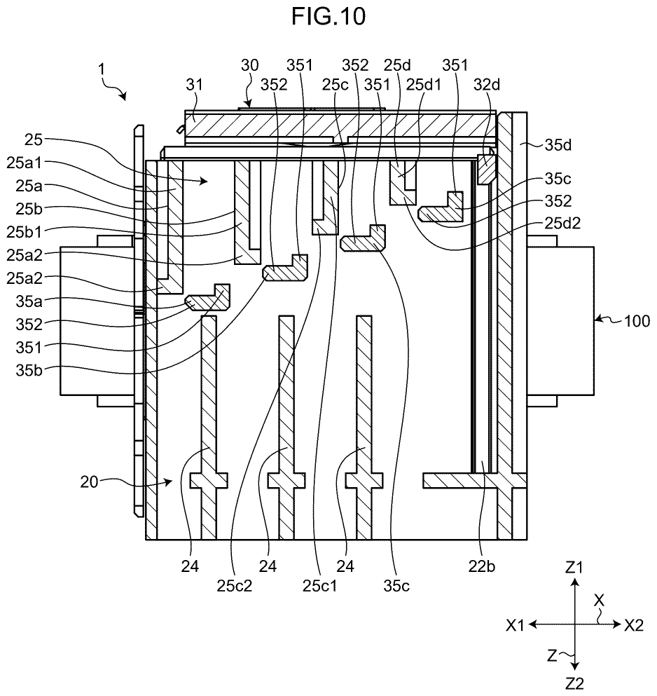

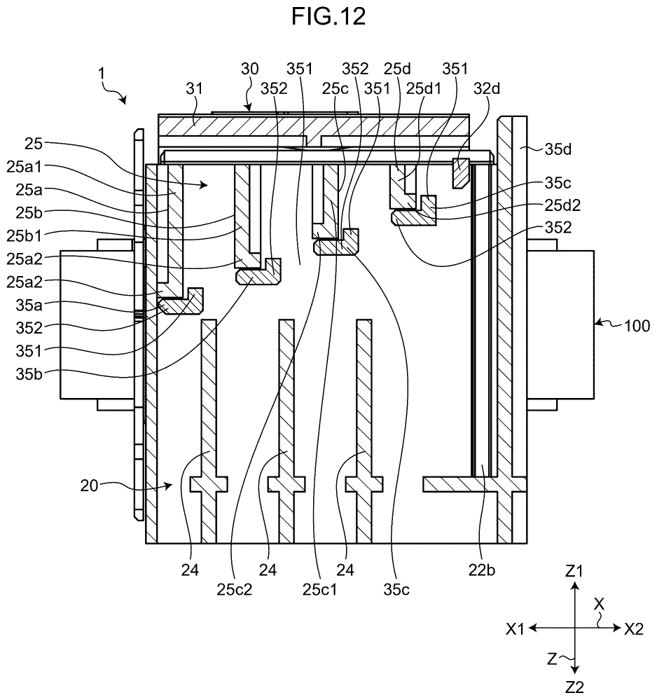

The cover side part 32 includes cover side locking parts 35 provided projecting from the inner side surface 32a. Although the details will be described below, the cover side locking part 35 is locked to the base side locking part 25 in such a way that the cover 30 and the base member 20 are moved relatively in a direction where the cover 30 and the base member 20 approach each other along the first direction X. The cover side locking parts 35 include four cover side locking parts 35a to 35d. Each of the four cover side locking parts 35a to 35d is formed in an approximately L-like shape whose part extending in the first direction X is long when viewed from the second direction Y (also see FIG. 10 and FIG. 12).

Each of the cover side locking parts 35a to 35d includes a slide locking part 352 that extends in the first direction X, and an auxiliary rib 351 that projects from an end part of the slide locking part 352 on the other side X2 in the first direction X to one side Z1 in the third direction Z. The cover side locking part 35a is provided on one side X1 in the first direction X while the cover side locking parts 35b, 35c, and 35d are provided in this order to the other side X2 in the first direction X. The cover side locking parts 35a to 35c exist on one side Z1 in the third direction Z compared to the cover side locking parts 35b to 35d adjacent on the other side X2 in the first direction X. Additionally, the cover side locking parts 35a to 35d are provided so that the position in the third direction Z comes to one side Z1 in this order to the other side X2 in the first direction X. That is to say, the cover side locking parts 35a to 35d are provided displaced along the third direction Z. In other words, the cover side locking parts 35a to 35d are disposed stepwise (also see FIG. 10 and FIG. 12).

Here, the base side locking parts 25a to 25d (locking reception parts 25a2 to 25d2) are also provided displaced along the third direction Z as described above. That is to say, a plurality of pairs of the cover side locking parts 35 and the base side locking parts 25, specifically the pairs of cover side locking parts 35a to 35d and base side locking parts 25a to 25d that are locked to each other are arranged along the first direction X and provided displaced along the third direction Z.

Each cover side part 32 includes a flexible part 32c that is formed by providing two slits 32b from an end part of each cover side part 32 on the other side X2 in the first direction X, and the locking projection part 32d projecting from a tip end of the flexible part 32c. The flexible part 32c is formed flexibly projecting from the cover side part 32 to the other side X2 in the first direction X. The locking projection part 32d is provided projecting from the flexible part 32c to the inside along the second direction Y, and is locked to the locking protrusion 22b of the base member 20. On one side X1 of the locking projection part 32d in the first direction X, a slide contact part 32d1 that is inclined is formed. At a projecting end of the locking projection part 32d, that is, on the other side X2 of the locking projection part 32d in the first direction X, a contact surface 32d2 in a flat shape is formed.

As illustrated in FIG. 7, the plate spring 40 is provided between the support part 31 of the cover 30 and the second core 12, and energizes the second core 12 toward the first core 11 along the third direction Z. More specifically, the plate spring 40 is formed in a mountain shape so that an approximately central part of the plate spring 40 in the first direction X is convex toward the other side Z2 in the third direction Z, and a top part of this mountain shape is in contact with the surface of the second core 12 on one side Z1 in the third direction Z. When the space between the support part 31 of the cover 30 and the second core 12 is narrowed, the two leg parts 42 of the plate spring 40 are opened, creating an elastic force in the plate spring 40. Since the cover 30 is fixed to the base member 20 and the first core 11 is supported by the bottom part 21 of the base member 20, the plate spring 40 is supported by the support part 31 and energizes the second core 12.

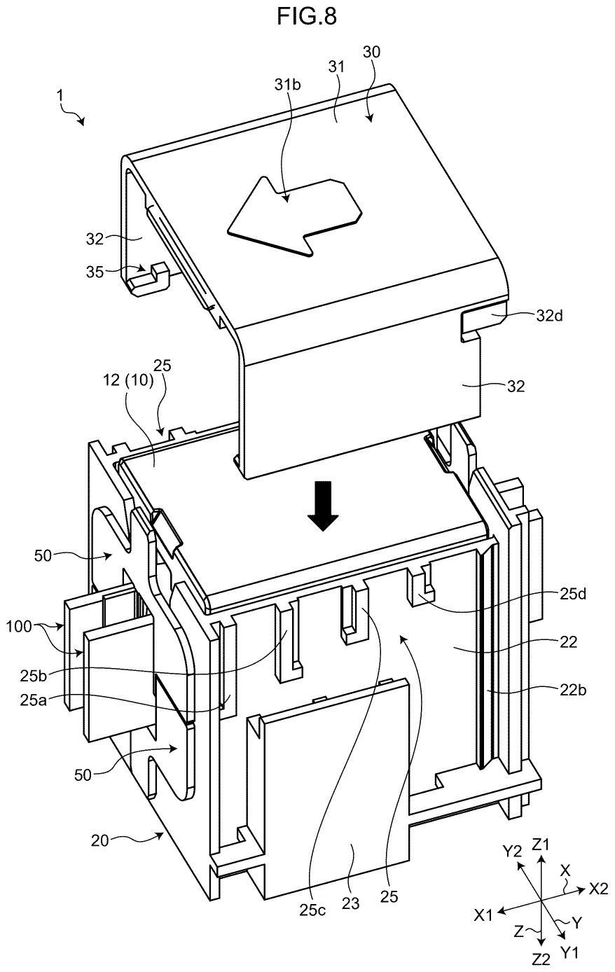

The cover 30 can be locked to the base member 20 by a sliding operation. When the cover 30 is locked to the base member 20, the first core 11 and the second core 12 of the magnetic core 10 are held in contact as described above. The cover 30 is slid as follows. As illustrated in FIG. 8, first, the first core 11, the bobbins 50, and the second core 12 are accommodated in the base member 20. Briefly speaking, the first core 11 with the contact surfaces 10a, 10b side facing one side Z1 in the third direction Z is accommodated in the base member 20. Then, the first core 11 is supported by the bottom part 21 of the base member 20 (the core support part 21a). The two bobbins 50 are then placed on the first core 11 and the second core 12 is accommodated in the base member 20 so that the second core 12 and the first core 11 are in contact with each other. Then, the busbar 100 is inserted to each of the two busbar insertion paths 58 formed by the bobbins 50, which are arranged facing each other.

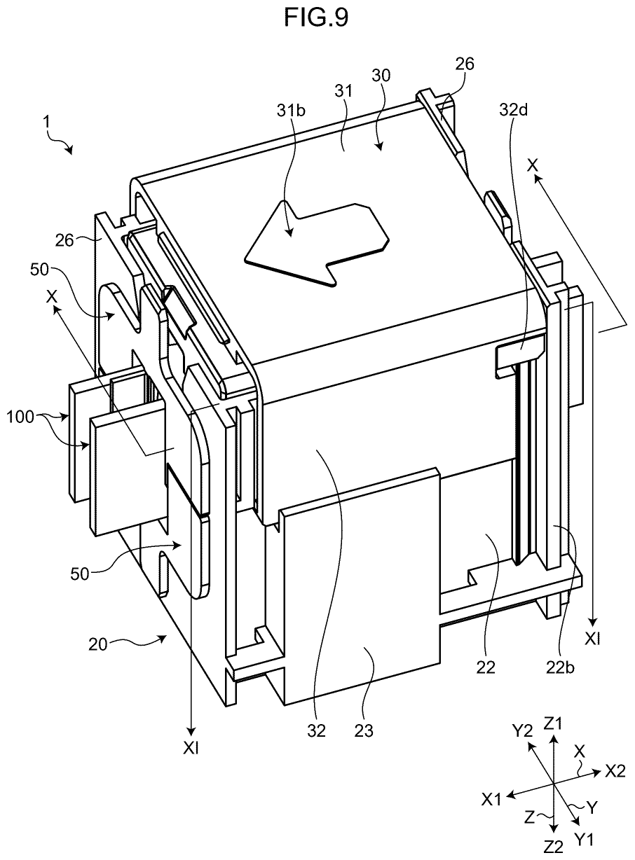

On the cover 30, the plate spring 40 is disposed on the other side Z2 in the third direction Z of the support part 31 as illustrated in FIG. 5. The cover 30 with the plate spring 40 set thereon is assembled from one side Z1 to the other side Z2 in the third direction Z (toward the base member 20) of the base member 20 that accommodates the magnetic core 10, etc., as illustrated in FIG. 8. At this time, the cover 30 is assembled with the arrow direction of the arrow display part 31b on the cover 30 oriented to one side X1 in the first direction X. Then, the state illustrated in FIG. 9 is obtained.

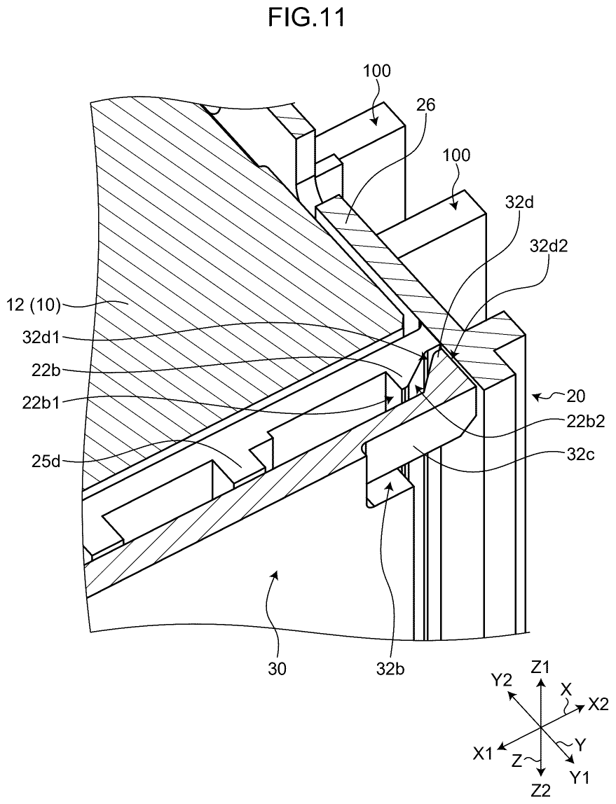

Here, the position of the cover 30 in the state in FIG. 9 relative to the base member 20 in the first direction X is the position where the cover side locking parts 35a to 35d are inserted between the base side locking parts 25a to 25d as illustrated in FIG. 10. In addition, the position of the cover 30 relative to the base member 20 in the second direction Y is the position where the cover side part 32 of the cover 30 is inserted to the space S1 between the sidewall part 22 of the base member 20 and the regulatory rib 23 with reference to FIG. 6. That is to say, the regulatory rib 23 is disposed outside the cover side part 32 in the second direction Y. Here, a tip end part of the cover side part 32 is inserted to the space S1. At this time, as illustrated in FIG. 11, the locking projection part 32d of the cover 30 exists on the other side X2 in the first direction X compared to the locking protrusion 22b of the base member 20. In other words, the slide contact part 32d1 of the locking projection part 32d and the inclined surface 22b2 of the locking protrusion 22b exist so as to face each other.

Then, the cover 30 is moved to one side X1 in the first direction X relative to the base member 20 by the slide operation. Here, in the state where the elastic force is not generated in the plate spring 40, the slide locking parts 352 of the cover side locking parts 35a to 35d may exist on one side in the third direction Z compared to the position illustrated in FIG. 10. Therefore, at the slide operation of the cover 30, the slide operation is performed while the cover 30 is pushed to the other side Z2 in the third direction Z. The plate spring 40 moves with the cover 30 because the movement of the plate spring 40 is regulated by the plate spring projection 34 of the cover 30.

When the cover 30 is slid, a surface of each slide locking part 352 of the cover side locking parts 35a to 35d on one side Z1 in the third direction Z comes into contact with a surface on the other side Z2 in the third direction Z of each of the locking reception parts 25a2, 25b2, 25c2, and 25d2 of the base side locking parts 25b2 to 25d existing on one side X1 in the first direction X as illustrated in FIG. 12. The cover 30 is energized to one side Z1 in the third direction Z relative to the base member 20; thus, the respective slide locking parts 352 are press-fitted to the locking reception parts 25a2, 25b2, 25c2, and 25d2. In this manner, the cover side locking part 35 and the base side locking part 25 are locked to each other. That is to say, the base side locking part 25 and the cover side locking part 35 are locked to each other in such a way that the cover 30 and the base member 20 are moved relatively so as to get close to each other along the first direction X. As the cover side locking part 35 and the base side locking part 25 are locked to each other, the support part 31 of the cover 30 is fixed relatively to the base member 20 particularly in the third direction Z. At this time, the elastic force is generated in the plate spring 40. Therefore, the plate spring 40 energizes the second core 12 toward the first core 11 supported by the base member 20 along the third direction Z. In this manner, the first core 11 and the second core 12 are in contact with each other at their contact surfaces 10a and 10b, and are held for sure.

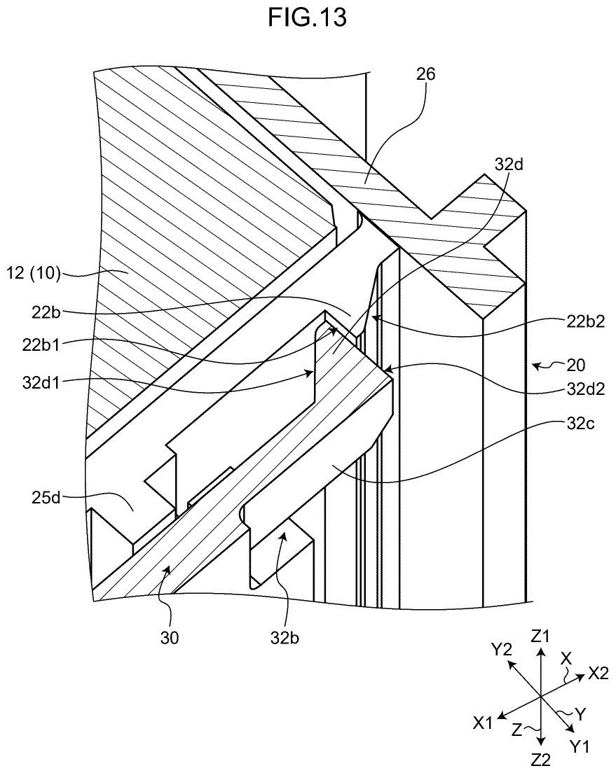

In addition, regarding the locking projection part 32d of the cover 30, the slide operation of the cover 30 causes the cover 30 to move to one side X1 in the first direction X, which makes the slide contact part 32d1 of the locking projection part 32d in slide contact with the inclined surface 25b2 of the locking protrusion 22b and go over the locking protrusion 22b as illustrated in FIG. 13. When the locking projection part 32d goes over the locking protrusion 22b, the restoring force resulting from the elastic flexibility of the flexible part 32c causes the locking projection part 32d to exist on one side X1 of the locking protrusion 22b in the first direction X. This makes it possible for the contact surface 32b2 of the projecting end of the locking projection part 32d to come into contact with the locking surface 22b1 of the locking protrusion 22b, thereby locking the locking projection part 32d and the locking protrusion 22b with each other. As the locking projection part 32d and the locking protrusion 22b are locked with each other, the movement of the cover 30 along the first direction X (the movement to the other side X2) is regulated.

The magnetic unit 1 described above includes: the magnetic core 10 formed in the annular shape about the first direction X and including the first core 11 and the second core 12 split along the second direction Y that intersects with the first direction X, in which the first core 11 and the second core 12 are in contact with each other along the third direction Z that intersects with the first direction X and the second direction Y; the base member 20 that accommodates the magnetic core 10 and includes the bottom part 21 that supports the first core 11 and the sidewall part 22 that is provided on the side of the magnetic core 10 in the second direction Y; the cover 30 including the support part 31 that is provided facing the second core 12 in the third direction Z and the cover side part 32 that is provided facing the sidewall part 22 in the second direction Y; and the plate spring 40 corresponding to the energizing member that is provided between the support part 31 and the second core 12 and configured to energize the second core 12 toward the first core 11 along the third direction Z, in which the base side locking part 25 is provided at the sidewall part 22, the cover side locking part 35 is provided at the cover side part 32, and the base side locking part 25 and the cover side locking part 35 are locked to each other by being moved relatively in the direction in which the cover 30 and the base member 20 approach each other along the first direction X.

Thus, the magnetic unit 1 can properly hold the magnetic core 10 by having the first core 11 and the second core 12 strongly abutted against each other by the simple slide operation of the cover 30.

For example, the cover 30 that holds the plate spring 40 may be attached to the base member 20 in such a way that the plate spring 40 is pressed with the cover 30 oriented from one side Z1 to the other side Z2 in the third direction Z. In this case, the cover 30 and the base member 20 may be locked to each other in such a way that a flexible part that is long in the third direction Z is provided in the cover 30, a locking part is provided at a tip end of the flexible part, and the locking part and a locked part provided in the base member 20 are locked to each other. In this case, the direction where the flexible part extends and the direction where the second core 12 is energized are the same, which is the third direction Z; therefore, a reaction force of the plate spring 40 is continuously applied to the flexible part.

In this embodiment, however, the base side locking part 25 and the cover side locking part 35 are locked by sliding the cover 30; therefore, the base side locking parts 25a to 25d and the cover side locking parts 35a to 35d, which have a non-flexible structure, can be employed and the power of holding the cover 30 in an extraction direction due to the reaction force of the plate spring 40 (a direction to one side Z1 in the third direction Z) can be improved.

In addition, in the base member 20, the regulatory rib 23 that is disposed outside the cover side part 32 in the second direction Y and regulates the movement of the cover side part 32 to the outside in the second direction Y is provided. Thus, in the cover 30 formed in the approximately U-like shape, the movement in the direction of opening the cover side part 32 by the external force can be regulated even if the cover side part 32 is flexible, and accordingly, the locking between the base side locking part 25 and the cover side locking part 35 can be made more certain. Additionally, the regulation of the cover side part 32 by the regulatory rib 23 is conducted at the tip end part of the cover side part 32; therefore, the opening of the cover side part 32 can be suppressed more certainly.

In addition, in the sidewall part 22, the locking protrusion 22b with the mountain-like cross-sectional shape extending along the third direction Z is provided, and in the cover side part 32, the flexible part 32c that is formed flexibly and projects along the first direction X and the locking projection part 32d that is provided in a projecting manner at the flexible part 32c and is locked to the locking protrusion 22b when the base side locking part 25 and the cover side locking part 35 are locked to each other are provided. Thus, the cover 30 can be locked to the base member 20 in the state where the base side locking part 25 and the cover side locking part 35 are locked to each other. The direction where the flexible part 32c projects is the first direction X, which is different from the extraction direction by the reaction force of the plate spring 40 (the direction toward one side Z1 in the third direction Z); therefore, the continuous reception of the strong force is avoided. Thus, the holding power of locking the locking protrusion 22b and the locking projection part 32d can be minimized and the workability improvement by the reduction of the inserting power can also be expected.

Moreover, a plurality of pairs of the cover side locking parts 35 and the base side locking parts 25 are arranged along the first direction X as the cover side locking parts 35a to 35d and the base side locking parts 25a to 25d and provided displaced along the third direction Z. Thus, the reaction force of the plate spring 40 to be applied to the cover side part 32 through the cover side locking parts 35a to 35d is not applied directly along the first direction X and is applied with diffusion; accordingly, the thickness of the cover side part 32 can be reduced.

The magnetic unit according to any of the embodiments of the present invention described above is not limited to the embodiment described above, and various changes can be made within the scope of the claims.

The base side locking parts 25 and the cover side locking parts 35 respectively include the four base side locking parts 25a to 25d and the four cover side locking parts 35a to 35d in the above description but may alternatively be formed by one or more base side locking parts and one or more cover side locking parts, respectively. Although the plate spring 40 is used as the energizing member that energizes the second core 12, another energizing member such as a coil spring may alternatively be used.

The magnetic unit according to this embodiment may be configured by combining the components in the embodiments and modifications described above as appropriate.

The magnetic unit according to the present embodiment has the effect that the magnetic core can be properly held.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic unit comprising:
a magnetic core formed in an annular shape about a first direction and including a first core and a second core split along a second direction that intersects with the first direction, in which the first core and the second core are in contact with each other along a third direction that intersects with the first direction and the second direction;
a base member that accommodates the magnetic core and includes a bottom part that supports the first core and a sidewall part that is provided on a side of the magnetic core in the second direction;
a cover including a support part that is provided facing the second core in the third direction and a cover side part that is provided facing the sidewall part in the second direction; and
an energizing member provided between the support part and the second core and configured to energize the second core toward the first core along the third direction, wherein a base side locking part is provided at the sidewall part,
a cover side locking part is provided at the cover side part, and
the base side locking part and the cover side locking part are locked to each other by being moved relatively in a direction in which the cover and the base member approach each other along the first direction.

2. The magnetic unit according to claim 1, wherein
in the base member, a regulatory rib that is disposed outside the cover side part in the second direction and regulates movement of the cover side part to the outside in the second direction is provided.

3. The magnetic unit according to claim 1, wherein
in the sidewall part, a locking protrusion with a mountain-like cross-sectional shape extending along the third direction is provided, and
in the cover side part, a flexible part that is formed flexibly and projects along the first direction and a locking projection part that is provided in a projecting manner at the flexible part and is locked to the locking protrusion when the base side locking part and the cover side locking part are locked to each other are provided.

4. The magnetic unit according to claim 2, wherein
in the sidewall part, a locking protrusion with a mountain-like cross-sectional shape extending along the third direction is provided, and
in the cover side part, a flexible part that is formed flexibly and projects along the first direction and a locking projection part that is provided in a projecting manner at the flexible part and is locked to the locking protrusion when the base side locking part and the cover side locking part are locked to each other are provided.

5. The magnetic unit according to claim 1, wherein
a plurality of pairs of the cover side locking parts and the base side locking parts are arranged along the first direction and provided displaced along the third direction.

6. The magnetic unit according to claim 2, wherein
a plurality of pairs of the cover side locking parts and the base side locking parts are arranged along the first direction and provided displaced along the third direction.
